(19) United States
(12) Patent Application Publication
(10) Pub. No.: US 2023/0412289 A1
(43) Pub. Date: Dec. 21, 2023

(54) INFORMATION PROCESSING APPARATUS, ASSOCIATION METHOD, AND SENSOR SYSTEM

(71) Applicant: Panasonic Intellectual Property Management Co., Ltd., Osaka (JP)

(72) Inventors: Tomohiro MURATA, Kanagawa (JP); Naganori SHIRAKATA, Kanagawa (JP); Koji TAKINAMI, Kanagawa (JP)

(21) Appl. No.: 18/360,574

(22) Filed: Jul. 27, 2023

Related U.S. Application Data
(63) Continuation of application No. PCT/JP2021/037437, filed on Oct. 8, 2021.

(30) Foreign Application Priority Data
Feb. 4, 2021 (JP) 2021-016779

(51) Int. Cl. H04B 17/318; H04B 17/27

(52) U.S. Cl. CPC H04B 17/318; H04B 17/27

(57) ABSTRACT

An information processing apparatus for associating an identifier of each of a plurality of sensors and a known installation position of a corresponding one of the plurality of sensors receives an identifier transmitted by a detection-complete sensor that has detected an object; associates, in a first path that is a part of the path, the identifier with an installation position of the detection-complete sensor in a reception order of a plurality of the identifiers; receives, from a detection-incomplete sensor that has not detected the object, reception strength information including an identifier of the detection-incomplete sensor and a reception strength of a signal of another one or more of the plurality of sensors in the detection-incomplete sensor; and associates, for the detection-incomplete sensor installed on a second path that is a rest of the path, the identifier of the detection-incomplete sensor and an installation position of the detection-incomplete sensor.

### TECHNICAL FIELD

The present disclosure relates to an information processing apparatus, an association method, and a sensor system.

### BACKGROUND ART

In recent years, with the rapid progress of IoT (Internet of Things), the use of sensors equipped with radio communication devices has been increasing. With the increase in use of such sensors, it is assumed that man-hours for manual work to associate known installation positions of sensors with individual identifiers (IDs) of the sensors increase, thus complicating the manual work during the initial setting.

Japanese Patent Application Laid Open No. 2017-227600 (hereinafter referred to as JP2017-227600) discloses a position estimating apparatus that associates installation positions of wireless communication devices and wireless communication device IDs without manual operation. When positions at which wireless communication devices are installed are known, but wireless communication device IDs for the positions are unknown, the position estimating apparatus of JP2017-227600 lists all combinations of the installation positions of the wireless communication devices and the wireless communication device IDs, and computes contradictions in all the combinations of the installation positions and wireless communication device IDs, by using received signal strengths of the wireless communication devices and information on distances between the respective wireless communication devices. The position estimating apparatus then compares the computed contradictions and associates an installation position of a wireless communication device with a low contradiction and a wireless communication device ID.

### CITATION LIST

### Patent Literature

PTL: Japanese Patent Application Laid Open No. 2017-227600

### SUMMARY OF INVENTION

However, the position estimating apparatus of JP2017-227600 requires large computational complexity for computing and comparing the contradictions in all the combination of the known installation positions and the unknown wireless communication device IDs of the wireless communication devices; hence, a problem with a large power consumption arises.

One non-limiting and exemplary embodiment facilitates providing an information processing apparatus, an association method, and a sensor system each capable of reducing power consumption.

An information processing apparatus according to an exemplary embodiment of the present disclosure is for associating an identifier of each of a plurality of sensors and a known installation position of a corresponding one of the plurality of sensors, the plurality of sensors being installed along a path and detecting an object traveling through the path, the information processing apparatus including: reception circuitry, which, in operation, receives an identifier transmitted by a detection-complete sensor that is one of the plurality of sensors and that has detected the object; and control circuitry, which, in operation, associates the identifier and an installation position of the detection-complete sensor, based on the received identifier and at least one of a plurality of the known installation positions of the plurality of sensors, in which the control circuitry, in a first path that is a part of the path, associates the identifier with the installation position of the detection-complete sensor in a reception order of a plurality of the identifiers, based on the plurality of known installation positions of the plurality of sensors, the reception circuitry receives, from a detection-incomplete sensor that is one of the plurality of sensors and that has not detected the object, reception strength information including an identifier of the detection-incomplete sensor and a reception strength of a signal of another one or more of the plurality of sensors in the detection-incomplete sensor, and the control circuitry associates, for the detection-incomplete sensor installed on a second path that is a rest of the path, the identifier of the detection-incomplete sensor and an installation position of the detection-incomplete sensor, based on the reception strength information and an installation-position relation with the plurality of sensors.

An association method according to an exemplary embodiment of the present disclosure is for an information processing apparatus for associating an identifier of each of a plurality of sensors and a known installation position of a corresponding one of the plurality of sensors, the plurality of sensors being installed along a path and detecting an object traveling through the path, the association method including: receiving an identifier transmitted by a detection-complete sensor that is one of the plurality of sensors and that has detected the object; associating, in a first path that is a part of the path, the identifier with an installation position of the detection-complete sensor in a reception order of a plurality of the identifiers, based on a plurality of the known installation positions of the plurality of sensors; receiving, from a detection-incomplete sensor that is one of the plurality of sensors and that has not detected the object, reception strength information including an identifier of the detection-incomplete sensor and a reception strength of a signal of another one or more of the plurality of sensors in the detection-incomplete sensor; and associating, for the detection-incomplete sensor installed on a second path that is a rest of the path, the identifier of the detection-incomplete sensor and an installation position of the detection-incomplete sensor, based on the reception strength information and an installation-position relation with the plurality of sensors.

A sensor system according to an exemplary embodiment of the present disclosure includes: a plurality of sensors that is installed along a path and detects an object traveling through the path; and an information processing apparatus that associates an identifier of each of the plurality of sensors and a known installation position of a corresponding one of the plurality of sensors, in which the information processing apparatus includes: reception circuitry, which, in operation, receives an identifier transmitted by a detection-complete sensor that is one of the plurality of sensors and that has detected the object; and control circuitry, which, in operation, associates the identifier and an installation position of the detection-complete sensor, based on the received identifier and at least one of a plurality of the known installation positions of the plurality of sensors, in which the control circuitry, in a first path that is a part of the path, associates the identifier with the installation position of the detection-complete sensor in a reception order of a plurality of the identifiers, based on the plurality of known installation positions of the plurality of sensors, the reception circuitry receives, from a detection-incomplete sensor that is one of the plurality of sensors and that has not detected the object, reception strength information including an identifier of the detection-incomplete sensor and a reception strength of a signal of another one or more of the plurality of sensors in the detection-incomplete sensor, and the control circuitry associates, for the detection-incomplete sensor installed on a second path that is a rest of the path, the identifier of the detection-incomplete sensor and an installation position of the detection-incomplete sensor, based on the reception strength information and an installation-position relation with the plurality of sensors.

It should be noted that general or specific embodiments may be implemented as a system, a method, an integrated circuit, a computer program, a storage medium, or any selective combination thereof.

According to an exemplary embodiment of the present disclosure, power consumption can be reduced in an information processing apparatus.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an exemplary configuration of a sensor system according to an embodiment of the present disclosure;

FIG. 2 illustrates an example of installation information that is input to an information processing apparatus;

FIG. 3 illustrates an exemplary association result between installation numbers of sensors and sensor IDs;

FIG. 4 illustrates an exemplary block configuration of the information processing apparatus;

FIG. 5 illustrates an exemplary block configuration of a sensor;

FIG. 6 illustrates an exemplary search tree;

FIG. 7 is a diagram for describing an example of association processing between installation positions and sensor IDs of sensors installed on a test path;

FIG. 8 illustrates exemplary fingerprints in sensors for which association is incomplete;

FIG. 9 is another diagram for describing an example of association processing between installation positions of sensors installed on a test path and sensor IDs;

FIG. 10 is a flowchart describing an exemplary operation of the information processing apparatus in a senor-installation estimation mode; and

FIG. 11 is another flowchart describing the exemplary operation of the information processing apparatus in the senor-installation estimation mode.

### DESCRIPTION OF EMBODIMENTS

Hereinafter, an embodiment of the present disclosure will be described in detail with reference to the accompanying drawings as appropriate. However, more detailed description than necessary may be omitted. For example, detailed descriptions of already well-known matters and repeated descriptions for substantially the same configuration may be omitted. This is to prevent the following description from becoming unnecessarily redundant and to facilitate understanding by a person skilled in the art.

Note that, the accompanying drawings and the following description are provided so that a person skilled in the art understands the present embodiment sufficiently, and are not intended to limit the subject matters recited in the claims.

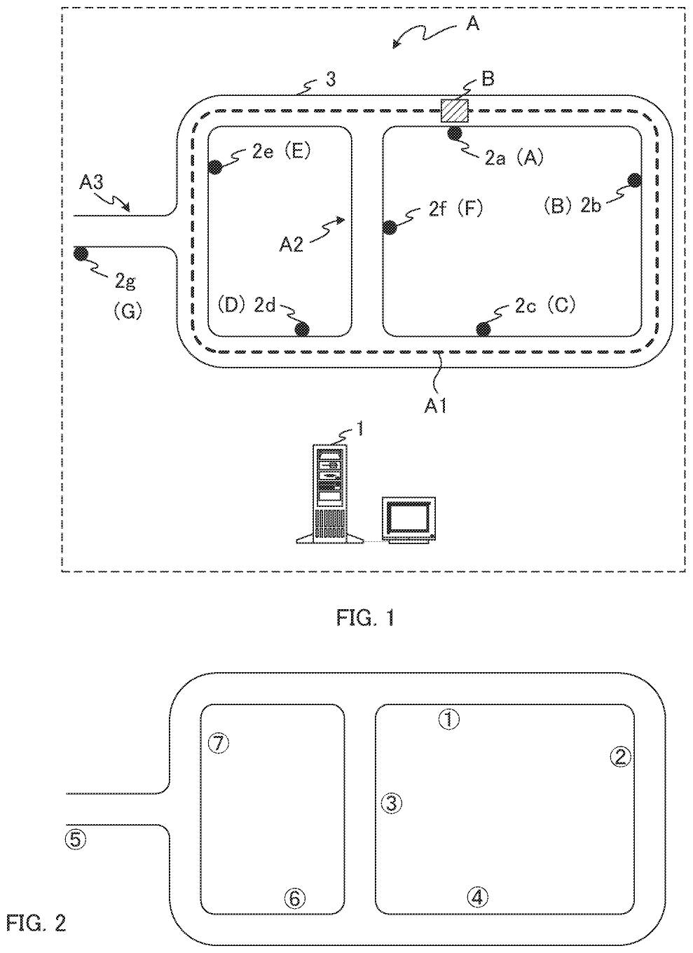

FIG. 1 illustrates an exemplary configuration of sensor system A according to an embodiment of the present disclosure. As illustrated in FIG. 1, sensor system A includes information processing apparatus 1 and sensors 2a to 2g. The capital letters A to G illustrated in FIG. 1 represent sensor IDs of sensors 2a to 2g, respectively.

In FIG. 1, belt conveyor 3 is illustrated. Belt conveyor 3 in FIG. 1 has a circulation path indicated by dotted line A1, a branch path indicated by arrow A2 that shortens the circulation path, and a branch path indicated by allow A3 that extends outward from the circulation path.

A conveyance path for object B to be conveyed with belt conveyor 3 may be set in accordance with an instruction of information processing apparatus 1, for example. Object B may be conveyed on a previously set path, by a conveyance apparatus such as an automated conveyance vehicle or a robot, not limited to belt conveyor 3.

Sensors 2a to 2g are installed, for example, along belt conveyor 3 to detect object B conveyed on belt conveyor 3. For example, sensors 2a to 2g are each a photosensor, which detects object B passing through in front of sensors 2a to 2g. Each of sensors 2a to 2g has a radio function and wirelessly transmits detection information indicating detection of object B to information processing apparatus 1. Incidentally, sensors 2a to 2g wirelessly communicate with one another.

Information processing apparatus 1 may be, for example, a server or a personal computer. Information processing apparatus 1 includes the following two operation modes: a sensor-installation estimation mode for associating known installation positions of sensors 2a to 2g and sensor IDs of sensors 2a to 2g; and a normal mode for monitoring whether object B is properly conveyed on belt conveyor 3.

In the normal mode, information processing apparatus 1 receives detection information that is transmitted wirelessly from sensors 2a to 2g. Information processing apparatus 1 monitors, based on the received detection information, whether object B conveyed is properly conveyed on belt conveyor 3 through a previously set path. Note that information processing apparatus 1 may operate in the normal mode after associating the installation positions of sensors 2a to 2g and the sensor IDs in the sensor-installation estimation mode.

In the sensor-installation estimation mode, to information processing apparatus 1, installation information is inputted by a user which indicates the installation positions of sensors 2a to 2g with respect to belt conveyor 3. The installation information indicates the installation positions of sensors 2a to 2g with respect to belt conveyor 3 and includes none of the sensor IDs of sensors 2a to 2g.

FIG. 2 illustrates an example of installation information that is inputted to information processing apparatus 1. The installation information includes information indicating a shape (path) of belt conveyor 3, as illustrated in FIG. 2. The installation information includes also information on installation numbers 1 to 7 indicating the installation positions of sensors 2a to 2g, respectively, as illustrated in FIG. 2. The installation numbers 1 to 7 may be given by information processing apparatus 1 or may be set by the user. The installation information indicates the installation positions of sensors 2a to 2g with respect to belt conveyor 3, as illustrated in FIG. 2.

Note that the installation information simply indicates the installation positions of sensors 2a to 2g with respect to belt conveyor 3 and does not indicate relations between the installation positions (installation numbers) of sensors 2a to 2g and the sensor IDs. In the sensor-installation estimation mode, information processing apparatus 1 uses the method to be described later so as to associate the installation numbers (installation positions) of sensors 2a to 2g and the sensor IDs.

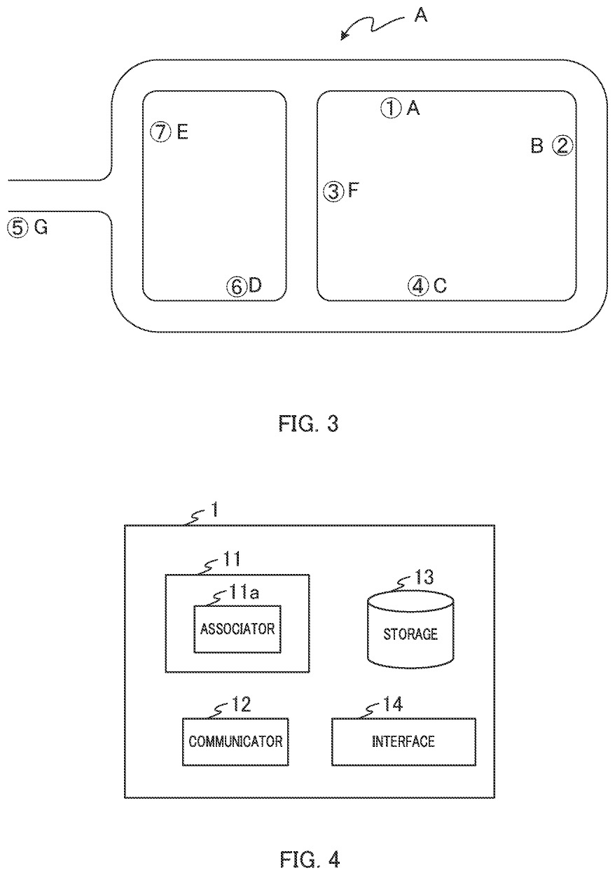

FIG. 3 illustrates an exemplary association result between installation numbers and sensor IDs of sensors 2a to 2g. The installation numbers illustrated in FIG. 3 represent the installation positions of sensors 2a to 2g with respect to belt conveyor 3, as with the installation numbers of FIG. 2. The capital letters A to G illustrated in FIG. 3 represent sensor IDs of sensors 2a to 2g, respectively.

Information processing apparatus 1 associates the installation numbers and the sensor IDs by the method to be described later. For example, information processing apparatus 1 associates the installation number 1 and the sensor ID “A,” as illustrated in FIG. 3. In the same manner, information processing apparatus 1 associates the installation numbers 2 to 7 and the sensor IDs “B” to “G,” respectively. This allows the user to understand that sensors with the sensor IDs “A” to “G” have been installed at the respective positions of the installation numbers 1 to 7 on belt conveyor 3.

For example, the user acquires, from information processing apparatus 1, an association result between the installation positions of sensors 2a to 2g and the sensor IDs of sensors 2a to 2g. This makes it possible for the user to install the sensors 2a to 2g on belt conveyor 3 without being aware of their sensor IDs and then acquire, from information processing apparatus 1, information on which of the sensor IDs of sensors 2a to 2g has been installed on which position on belt conveyor 3.

Note that the method of associating an installation position and a sensor ID to be described later suppresses the computation cost of information processing apparatus 1. As a result, information processing apparatus 1 can reduce power consumption.

FIG. 4 illustrates an exemplary block configuration of information processing apparatus 1. As illustrated in FIG. 4, information processing apparatus 1 includes controller 11, communicator 12, storage 13, and interface 14.

Controller 11 may be configured with, for example, a processor such a Central Processing Unit (CPU) or a Digital Signal Processor (DSP). Controller 11 controls the entirety of information processing apparatus 1. Controller 11 includes associator 11a for associating installation numbers of sensors 2a to 2g and sensor IDs of sensors 2a to 2g.

Communicator 12 performs radio communication with sensors 2a to 2g by using, for example, wireless communication such as Wi-Fi (registered trademark), Bluetooth (registered trademark), or WiGig (registered trademark).

Storage 13 stores a program for operation of controller 11. A function of associator 11a may be implemented by controller 11 executing the program. Further, storage 13 stores data for controller 11 to perform computation processing or data for controller 11 to control each component. Storage 13 may be configured by memory apparatuses such as a Random Access Memory (RAM), a Read Only Memory (ROM), a flash memory, and a Hard Disk Drive (HDD). Interface 14 includes, for example, an input (not illustrated) for receiving a signal received from a key-input apparatus and outputting the signal to controller 11. Interface 14 includes also, for example, an output (not illustrated) for outputting a signal transmitted from controller 11, to a display apparatus.

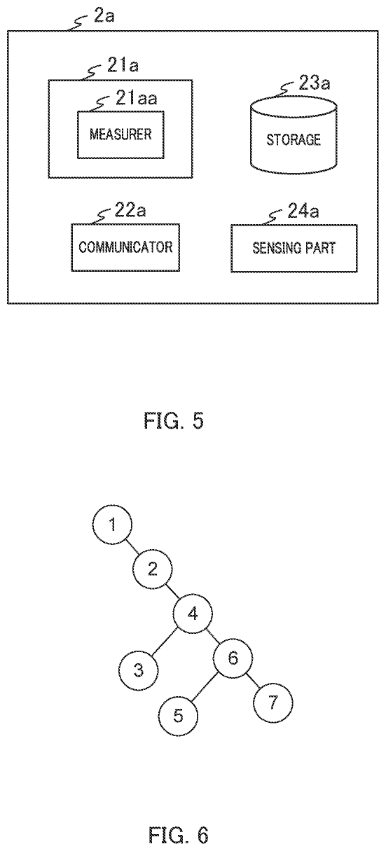

FIG. 5 illustrates an exemplary block configuration of sensor 2a. As illustrated in FIG. 5, sensor 2a includes controller 21a, communicator 22a, storage 23a, and sensing part 24a.

Controller 21a may be configured with, for example, a processor such as a CPU or a DSP. Controller 21a controls the entirety of sensor 2a. Controller 21a includes measurer 21aa for measuring a reception strength of each signal from other sensors 2b to 2g. In response to an instruction from information processing apparatus 1, measurer 21aa transmits, to information processing apparatus 1, reception strength information including the reception strength.

The reception strength of a signal may be, for example, Received signal strength indication (RSSI), a signal-to-noise ratio (SNR), or a Signal-to-interference-plus-noise ratio (SINR). The reception strength information may include a sensor ID of a sensor that has transmitted a signal for which the reception strength is measured and a sensor ID of a sensor that has received the signal.

Communicator 22a performs radio communication with sensors 2b to 2g by using, for example, wireless communication such as Wi-Fi, Bluetooth, or WiGig. Also, communicator 22a performs radio communication with information processing apparatus 1 by using, for example, wireless communication such as Wi-Fi or Bluetooth.

Storage 23a stores a program for operation of controller 21a. A function of measurer 21aa may be implemented by controller 21a executing the program. Storage 32a stores data for controller 21a to perform computation processing, data for controller 21a to control each component, and the sensor ID of sensor 2a. The sensor ID may be, for example, a Media Access Control (MAC) address. Storage 23a may be configured by memory apparatuses such the RAM, the ROM, the flash memory, and the HDD.

Sensing part 24a detects passing-through of object B flowing on belt conveyor 3. For example, sensing part 24a may emit light and receive reflected light, and then, based on the received light, detect the passing-through of object B. Incidentally, sensing part 24a may be a proximity sensor, an infrared sensor, a sound wave sensor, a Radio Frequency Identifier (RFID), or a radar. A range where sensing part 24a detects object B may be referred to as a detection range.

Hereinafter, a description will be given of an association method between installation positions and sensor IDs of sensors 2a to 2g.

1. Generation Processing of Search Tree

Information processing apparatus 1 generates, based on installation information inputted by a user, a search tree indicating a relation between installation positions (hereinafter may also be referred to as “installation-position relation”) of sensors 2a to 2g with respect to a path of belt conveyor 3.

FIG. 6 illustrates an exemplary search tree. The numbers illustrated in FIG. 6 respectively correspond to the installation numbers 1 to 7 of sensors 2a to 2g described in FIG. 2.

For example, in FIG. 2, between the installation numbers 4 and 6, belt conveyor 3 has a branch path to which the installation number 3 is given. Hence, the search tree of FIG. 6 includes the installation numbers 3 and 6 branched off from the installation number 4.

Further, in FIG. 2, between the installation numbers 6 and 7, belt conveyor 3 has a branch path to which the installation number 5 is given. Hence, the search tree of FIG. 6 includes the installation numbers 5 and 7 branched off from the installation number 6. Incidentally, each branch path may be referred to as a second path.

2. Association Processing Between Installation Positions of Sensors and Sensor IDs Installed in Test Path

After generating the search tree, information processing apparatus 1 sets a path through which object B flows on belt conveyor 3. This path may be different from a path through which object B is conveyed in the normal mode. Information processing apparatus 1 may set the path such that, for example, the number of sensors that detect object B is maximized. Alternatively, information processing apparatus 1 may set the path such that object B travels over the widest range on belt conveyor 3. In the following, in the sensor-installation estimation mode, a path through which object B flows is sometimes referred to as a test path or a first path. The test path may be set at random by the user.

Further, in the following, the test path is in the order of installation numbers 1, 2, 4, 6, and 7 illustrated in FIG. 2. For example, object B first passes through in front of sensor 2a of FIG. 1 and then travels the circulation path indicated by dotted line A1 in the order of sensor 2b, sensor 2c, sensor 2d, and sensor 2e. The test path may be recognized as information indicating, by the installation numbers, the order of sensors 2a to 2e that detect object B information and may be also referred to as detection-order information.

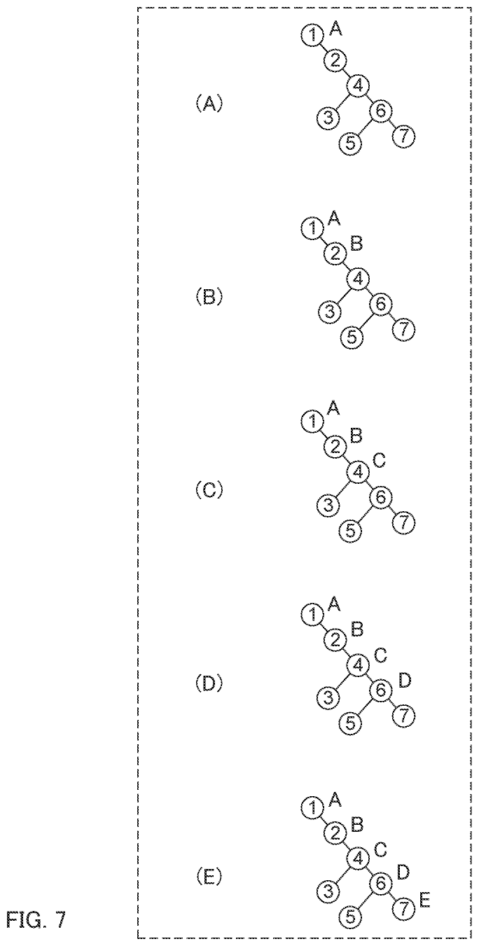

FIG. 7 is a diagram for describing an example of the association processing between installation positions and sensor IDs of the sensors installed on the test path. FIG. 7 illustrates the search tree described in FIG. 6.

The user lets object B to flow on belt conveyor 3 through the test path that has been set by information processing apparatus 1. Object B first passes through in front of sensor 2a installed on installation number 1.

Sensor 2a detects object B passing through in front of sensor 2a and transmits detection information including the sensor ID “A” to information processing apparatus 1.

Information processing apparatus 1 determines, based on information on the test path (installation numbers 1, 2, 4, 6, and 7) that has been set, that the detection information received for the first time is from a sensor installed on installation number 1. Accordingly, as illustrated in (A) of FIG. 7, information processing apparatus 1 associates the installation number 1 and the sensor ID “A” that is included in the received detection information. Incidentally, when the user lets object B to flow on belt conveyor 3 from the middle of the test path, the user inputs the installation number of the closest sensor into information processing apparatus 1.

Object B that has passed through in front of sensor 2a then passes through in front of sensor 2b. Sensor 2b detects object B passing through in front of sensor 2b and transmits detection information including the sensor ID “B” to information processing apparatus 1.

Information processing apparatus 1 determines, based on the information on the test path that has been set, that the detection information received next is from a sensor installed on installation number 2. Accordingly, as illustrated in (B) of FIG. 7, information processing apparatus 1 associates the installation number 2 and the sensor ID “B” that is included in the received detection information.

Object B that has passed through in front of sensor 2b then passes through in front of sensor 2c. Sensor 2c detects object B passing through in front of sensor 2c and transmits detection information including the sensor ID “C” to information processing apparatus 1.

Information processing apparatus 1 determines, based on the information on the test path that has been set, that the detection information received next is from a sensor installed on installation number 4. Accordingly, as illustrated in (C) of FIG. 7, information processing apparatus 1 associates the installation number 4 and the sensor ID “C” that is included in the received detection information.

Object B that has passed through in front of sensor 2c then passes through in front of sensor 2d. Sensor 2d detects object B passing through in front of sensor 2d and transmits detection information including the sensor ID “D” to information processing apparatus 1.

Information processing apparatus 1 determines, based on the information on the test path that has been set, that the detection information received next is from a sensor installed on installation number 6. Accordingly, as illustrated in (D) of FIG. 7, information processing apparatus 1 associates the installation number 6 and the sensor ID “D” that is included in the received detection information.

Object B that has passed through in front of sensor 2d then passes through in front of sensor 2e. Sensor 2e detects object B passing through in front of sensor 2e and transmits detection information including the sensor ID “E” to information processing apparatus 1.

Information processing apparatus 1 determines, based on the information on the test path that has been set, that the detection information received next is from a sensor installed on installation number 7. Accordingly, as illustrated in (E) of FIG. 7, information processing apparatus 1 associates the installation number 7 and the sensor ID “E” that is included in the received detection information.

For example, information processing apparatus 1 may sequentially associate the identifiers transmitted by sensors 2a to 2e that have detect object B traveling through the test path and the installation positions of sensors 2a to 2e, in accordance with the passing-through order in front of sensors 2a to 2e of object B traveling through the test path.

The above conveyance of object B on the test path, association between the installation positions of sensors 2a to 2e with installation numbers 1, 2, 4, 6, and 7 installed on the test path and the sensor ID thereof is complete. In contrast, association between installation positions of sensors 2f and 2g with installation numbers 3 and 5 which are not installed on the test path and sensor ID thereof is incomplete. Sensors 2a to 2e that have detected object B may be each referred to as a detection-complete sensor. Sensors 2f and 2g that have not detected object B and for which the association is incomplete may be each referred to as a detection-incomplete sensor.

3. Association Processing Between Installation Positions and Sensor IDs of Sensors Installed Outside Test Path

For detection-incomplete sensors 2f and 2g, information processing apparatus 1 associates the installation positions of detection-incomplete sensors 2f and 2g and the sensor IDs thereof by using distances between detection-incomplete sensors 2f and 2g and detection-complete sensors 2a to 2e, and fingerprints of detection-incomplete sensors 2f and 2g.

For example, information processing apparatus 1 may associate the installation positions of detection-incomplete sensors 2f and 2g and the sensor IDs thereof, by using a correlation between the distances from detection-incomplete sensors 2f and 2g to detection-complete sensors 2a to 2e and the fingerprints of detection-incomplete sensors 2f and 2g.

For example, in response to an instruction from information processing apparatus 1, detection-incomplete sensors 2f and 2g measure a reception strength of each signal transmitted from other sensors 2a to 2e to generate the fingerprints. Detection-incomplete sensors 2f and 2g transmit, to information processing apparatus 1, the generated fingerprints and sensor IDs “F” and “G” of sensors 2f and 2g.

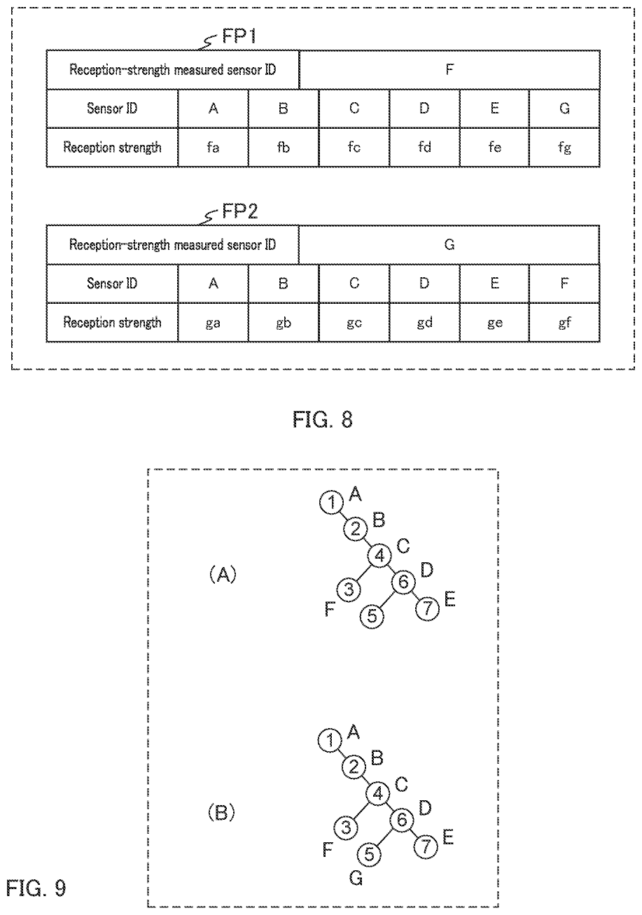

FIG. 8 illustrates exemplary fingerprints in detection-incomplete sensors 2f and 2g. The fingerprint FP1 illustrated in FIG. 8 indicates a fingerprint of sensor 2f. Fingerprint FP1 includes the sensor ID of sensor 2f that has measured reception strengths and the reception strengths of other sensors 2a to 2e, and 2g in association-incomplete sensor 2f The fingerprint FP2 illustrated in FIG. 8 indicates a fingerprint of sensor 2g.

Fingerprint FP2 includes the sensor ID of sensor 2g that has measured reception strengths and the reception strengths of other sensors 2a to 2f in association-incomplete sensor 2g.

After receiving the fingerprints FP1 and FP2 from detection-incomplete sensors 2f and 2g, information processing apparatus 1 sorts the reception strengths in each of fingerprints FP1 and FP2 in the descending order. Hereinafter, a magnitude relation of the reception strengths in fingerprint FP1 of association-incomplete sensor 2f is assumed to have, for example, the following Relation 1 (see, e.g., distances from sensor 2f to sensors 2a to 2e, and 2g illustrated in FIG. 1).

fa>fd>fc>fe>fb>fg (Relation 1)

Further, in the following, a magnitude relation of the reception strengths in fingerprint FP2 of association-incomplete sensor 2g is assumed to have, for example, the following Relationship 2 (see, e.g., distances from sensor 2g to sensors 2a to 2f illustrated in FIG. 1).

ge>gd>gf>ga>gc>gb (Relation 2)

After sorting the reception strengths in each of fingerprints FP1 and FP2 in the descending order, information processing apparatus 1 assumes that association-incomplete sensor 2f is installed on the installation position of the installation number 5 for which the association is incomplete.

Here, in the example of FIG. 2, an installation number of an installation position that is closest to the installation position of the association-incomplete installation number 5 is the installation number 7. Therefore, of the reception strengths in fingerprint FP1 of sensor 2f assumed to be installed on the installation number 5, it is estimated that the reception strength of the signal from sensor 2e installed on the installation number 7 is the largest. Note that information processing apparatus 1 identifies, based on the installation information inputted by the user, the installation number 7 of the installation position that is closest to the installation position of the installation number 5.

However, the reception strength of the signal received by sensor 2f from sensor 2e is the fourth largest, as indicated in above Relation 1. Hence, information processing apparatus 1 determines that the assumption of installation of sensor 2f on the installation number 5 is incorrect. For example, information processing apparatus 1 may determine that association-incomplete sensor 2f is not installed on the installation position of the association-incomplete installation number 5.

Next, information processing apparatus 1 assumes that association-incomplete sensor 2f is installed on the installation position of the association-incomplete installation number 3.

Here, in the example of FIG. 2, an installation number of an installation position that is closest to the installation position of the association-incomplete installation number 3 is the installation number 1. Therefore, of the reception strengths in fingerprint FP1 of sensor 2f assumed to be installed on the installation number 3, it is estimated that the reception strength of the signal from sensor 2a installed on the installation number 1 is the largest. Note that information processing apparatus 1 identifies, based on the installation information inputted by the user, the installation number 1 of the installation position that is closest to the installation position of the installation number 3.

The reception strength of the signal received by sensor 2f from sensor 2a is the largest, as indicated in above Relation 1. Hence, information processing apparatus 1 determines that the assumption of installation of sensor 2f on the installation number 3 is correct. For example, information processing apparatus 1 determines that sensor 2f is installed on the installation position of the installation number 3. Information processing apparatus 1 may then associate the installation number 3 and the sensor ID “F” of sensor 2f, as illustrated in (A) of FIG. 9.

Next, information processing apparatus 1 assumes that association-incomplete sensor 2g is installed on the installation position of the association-incomplete installation number 5.

Here, in the example of FIG. 2, an installation number of an installation position that is closest to the installation position of the association-incomplete installation number 5 is the installation number 7. Therefore, of the reception strengths in fingerprint FP2 of sensor 2g assumed to be installed on the installation number 5, it is estimated that the reception strength of the signal from sensor 2e installed on the installation number 7 is the largest. Note that information processing apparatus 1 identifies, based on the installation information inputted by the user, the installation number 7 of the installation position that is closest to the installation position of the installation number 5.

The reception strength of the signal received by sensor 2g from sensor 2e is the largest, as indicated in above Relation 2. Hence, information processing apparatus 1 determines that the assumption of installation of sensor 2g on the installation number 5 is correct. For example, information processing apparatus 1 determines that sensor 2g is installed on the installation position of the installation number 5. Information processing apparatus 1 may then associate the installation number 5 and the sensor ID “G” of sensor 2g, as illustrated in (B) of FIG. 9.

Through the above processing, information processing apparatus 1 associates the association-incomplete installation numbers 3 and 5 and the sensor IDs of detection-incomplete sensors 2f and 2g, respectively.

Note that, in the above description, information processing apparatus 1 sorts the reception strengths in the descending order, but the sort may be in the ascending order.

Further, since the reception strength, fa, is the largest in Relation 1 in fingerprint FP1, information processing apparatus 1 may provisionally associate sensor 2f with a sensor having the installation number 3 that is an association-incomplete sensor around sensor 2a having the installation number 1. Further, since the reception strength, ge, is the largest in Relation 2 in fingerprint FP2, information processing apparatus 1 may provisionally associate sensor 2g with a sensor having the installation number 5 that is an association-incomplete sensor around sensor 2e having the installation number 7. In a case where there is no other association-incomplete sensors, information processing apparatus 1 may associate the provisionally associated sensors as they are.

Incidentally, in fingerprints FP1 and FP2, when the order of reception strengths is the same up to the middle, e.g., when fa is the largest reception strength in Relation 1 and ga is the largest reception strength in Relation 2, a sensor to be associated may be determined by using the second or subsequent reception strength.

Information processing apparatus 1 may acquire a plurality of installation numbers close to the installation number of the installation position where an association-incomplete sensor is assumed to be installed. For example, information processing apparatus 1 may acquire the installation numbers that are closest, the second closest, and the third closest to the installation number of the installation position where the association-incomplete sensor is assumed to be installed. Information processing apparatus 1 may then associate the sensor ID of the association-incomplete sensor and the association-incomplete installation number, based on distances from sensors installed on the three acquired installation numbers to the association-incomplete sensor, and reception strengths, which are sorted in the order of magnitude, in the fingerprint of the association-incomplete sensor.

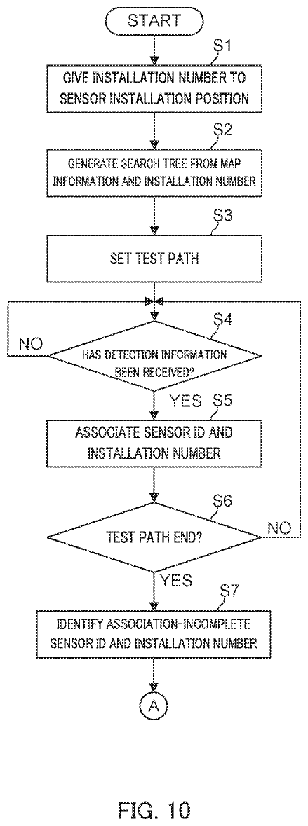

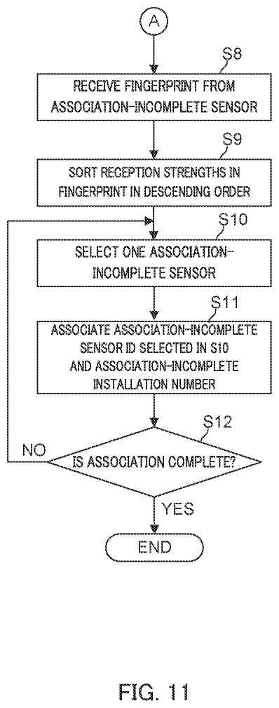

FIGS. 10 and 11 illustrate a flowchart describing an exemplary operation of the information processing apparatus 1 in the senor-installation estimation mode. The flowchart illustrated in FIGS. 10 and 11 continues in processing in “A” in FIGS. 10 and 11. Suppose the installation information is inputted to information processing apparatus 1.

Information processing apparatus 1 gives installation numbers to installation positions of sensors 2a to 2g with respect to belt conveyor 3, based on the inputted installation information (S1). For example, information processing apparatus 1 gives installation numbers 1 to 7, as illustrated in FIG. 2.

Information processing apparatus 1 generates a search tree using the installation numbers of S1, based on the inputted installation information (S2). For example, information processing apparatus 1 generates the search tree, as illustrated in FIG. 6.

Information processing apparatus 1 sets a test path through which object B flows (S3). The users puts object B onto belt conveyor 3. Belt conveyor 3 conveys object B through the test path that has been set by information processing apparatus 1. Incidentally, when the user lets object B to flow on belt conveyor 3 from the middle of the test path, the user inputs the installation number of the closest sensor into information processing apparatus 1.

Information processing apparatus 1 determines whether detection information has been received from sensors 2a to 2g (S4).

When determining that the detection information has been received (S4: YES), information processing apparatus 1 associates sensor IDs included in the received detection information and installation numbers (installation positions) (S5). By way of example, as described with reference to FIG. 7, information processing apparatus 1 sequentially associates sensor IDs transmitted by sensors that have detected object B and installation numbers of the sensors that have transmitted the sensor IDs, based on detection-order information indicating, by installation numbers, the order of sensors that detect object B.

Information processing apparatus 1 determines whether an installation number associated with a sensor ID is at an end of the test path (S6).

When determining that the installation number associated with the sensor ID is not at the end of the test path (S6: NO), information processing apparatus 1 shifts the processing to S4.

On the other hand, when determining that the installation number associated with the sensor ID is at the end of the test path (S6: YES), information processing apparatus 1 identifies sensor IDs of association-incomplete sensors and association-incomplete installation numbers (S7).

Information processing apparatus 1 receives fingerprints from the association-incomplete sensors (S8). By way of example, information processing apparatus 1 receives fingerprints FP1 and FP2 from detection-incomplete sensors 2f and 2g, as described with reference to FIG. 8.

Information processing apparatus 1 sorts reception strengths in the fingerprint received in S8, in the descending order (S9). By way of example, information processing apparatus 1 sorts reception strengths of fingerprints FP1 and FP2 in the descending order, as indicated in the above Relations 1 and 2.

Information processing apparatus 1 selects one association-incomplete sensor (S10).

Information processing apparatus 1 associates an ID of the association-incomplete sensor selected in S10 and an association-incomplete installation number, based on distances from the association-incomplete sensor selected in S10 to other sensors, and the reception strengths sorted in S9, in the association-incomplete sensor selected in S10 (S11).

Information processing apparatus 1 determines whether the association of installation numbers is complete for all association-incomplete sensors (S12).

When determining the association of installation numbers is not complete for all the association-incomplete sensors (S12: NO), information processing apparatus 1 shifts the processing to S10. When determining the association of installation numbers is complete for all the association-incomplete sensors (S12: YES), information processing apparatus 1 ends the flowchart processing.

As described above, information processing apparatus 1 associates sensor IDs of multiple sensors 2a to 2g, which are installed along belt conveyor 3 and detect object B, and installation positions of multiple sensors 2a to 2g. Information processing apparatus 1 includes communicator 12 that receives a sensor ID transmitted by a sensor that has detected object B. Information processing apparatus 1 includes controller 11 that associates the received sensor ID and an installation position of the sensor that has transmitted the sensor ID, based on the reception order of sensor IDs and detection-order information indicating, by installation positions, the order of the sensors that detect object B.

Communicator 12 receives, from an association-incomplete sensor that has not transmitted a sensor ID because of no passing-through of object B, a sensor ID of the association-incomplete sensor and a fingerprint including reception strengths of signals from other sensors in the association-incomplete sensor. Controller 11 associates the sensor ID of the association-incomplete sensor and an installation position of the association-incomplete sensor, based on the received fingerprint and installation-position relations with the respective sensors.

With respect to a sensor ID of a sensor that has detected object B, information processing apparatus 1 may associate the sensor ID transmitted from the sensor that has detected object B and an installation position of the sensor, based on the detection-order information, for example.

On the other hand, with respect to a sensor ID of an association-incomplete sensor that has not transmitted the sensor ID because of no passing-through of object B, information processing apparatus 1 associates the sensor ID of the association-incomplete sensor and an installation position of the association-incomplete sensor, based on a fingerprint in the association-incomplete sensor and installation-position relations with the respective sensors (e.g., distances between association-incomplete sensor and other sensors). By way of example, information processing apparatus 1 may perform, on a sensor that has not transmitted a sensor ID, the association processing that is based on a fingerprint and installation-position relations with the respective sensors.

Here, the association processing based on the detection-order information requires less computational complexity because the processing is simple compared with the association processing based on a fingerprint and installation-position relations with the respective sensors. Information processing apparatus 1 performs a part of the association processing between sensor IDs and installation positions, based on the detection-order information, thus reducing the computational complexity as compared with the case of performing all of the association processing between sensor IDs and installation positions, based on fingerprints and installation-position relations with the respective sensors. As a result, information processing apparatus 1 can reduce power consumption.

Note that, in the above, information processing apparatus 1 may execute the operation of the sensor-installation estimation mode at a previously determined period.

Meanwhile, with respect to the reception strength, reception strengths between information processing apparatus 1 and sensors 2a to 2g may be used, in addition to the reception strength between sensors 2a to 2g.

A network topology between information processing apparatus 1 and sensors 2a to 2g may be a star type centered on information processing apparatus 1 or a mesh type. Alternatively, the star type and the mesh type may be combined.

Further, in a case where an area for sensor system A is so wide that it is difficult to directly connect between information processing apparatus 1 and sensors 2a to 2g, some of sensors 2a to 2g may be used as a repeater to perform multi-hop communication.

Further, in the above, a case has been described where information processing apparatus 1 aggregates the information to associate installation positions of sensors and sensor IDs of the sensors, but the present disclosure is not limited to this case. At least one of sensors 2a to 2g of sensor system A may be serve as information processing apparatus 1 described above.

Further, information processing apparatus 1 has used a reception strength to associate an installation position of an association-incomplete sensor and a sensor ID, but the present disclosure is not limited to this. Information processing apparatus 1 may use, for example, a packet-error rate to an installation position of an association-incomplete sensor and a sensor ID.

Further, a case has been described where information processing apparatus 1 and sensors 2a to 2g perform radio communication with one another, but the present disclosure is not limited to this case. Information processing apparatus 1 and sensors 2a to 2g may perform wired communication with one another.

Further, information processing apparatus 1 may execute the sensor-installation estimation mode at a certain period during the operation in the normal mode.

In the description of the embodiment described above, the term, such as “part” or “portion” or the term ending with a suffix, such as “-er” “-or” or “-ar” may be replaced with another term, such as “circuit (circuitry),” “device,” “unit,” or “module.”

The description has been given of an embodiment with reference to the drawings, but the present disclosure is not limited to the examples. It is apparent that variations or modifications in the category described in the claims may be conceived of by a person skilled in the art. It is to be understood that such variations or modifications fall within the technical scope of the present disclosure. In addition, component elements in the embodiment may be optionally combined without departure from the spirit of the present disclosure.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied. The disclosure of Japanese Patent Application No. 2021-016779, filed on Feb. 4, 2021, including the specification, drawings and abstract, is incorporated herein by reference in its entirety.

### INDUSTRIAL APPLICABILITY

The present disclosure is useful for an initial setting of a sensor group used in a system moving on a path.

### REFERENCE SIGNS LIST

A Sensor system
B Object
1 Information processing apparatus
2a to 2g Sensor
3 Belt conveyor

1. An information processing apparatus for associating an identifier of each of a plurality of sensors and a known installation position of a corresponding one of the plurality of sensors, the plurality of sensors being installed along a path and detecting an object traveling through the path, the information processing apparatus comprising:
reception circuitry, which, in operation, receives an identifier transmitted by a detection-complete sensor that is one of the plurality of sensors and that has detected the object; and
control circuitry, which, in operation, associates the identifier and an installation position of the detection-complete sensor, based on the received identifier and at least one of a plurality of the known installation positions of the plurality of sensors,
wherein
the control circuitry, in a first path that is a part of the path, associates the identifier with the installation position of the detection-complete sensor in a reception order of a plurality of the identifiers, based on the plurality of known installation positions of the plurality of sensors,
the reception circuitry receives, from a detection-incomplete sensor that is one of the plurality of sensors and that has not detected the object, reception strength information including an identifier of the detection-incomplete sensor and a reception strength of a signal of another one or more of the plurality of sensors in the detection-incomplete sensor, and
the control circuitry associates, for the detection-incomplete sensor installed on a second path that is a rest of the path, the identifier of the detection-incomplete sensor and an installation position of the detection-incomplete sensor, based on the reception strength information and an installation-position relation with the plurality of sensors.

2. The information processing apparatus according to claim 1, wherein the control circuitry sets, as the first path, a path through which the object travels such that the number of sensors that detect the object is maximized.

3. The information processing apparatus according to claim 1, wherein the control circuitry sets, as the first path, a path through which the object travels such that the object travels over the widest range.

4. An association method for an information processing apparatus for associating an identifier of each of a plurality of sensors and a known installation position of a corresponding one of the plurality of sensors, the plurality of sensors being installed along a path and detecting an object traveling through the path, the association method comprising:
receiving an identifier transmitted by a detection-complete sensor that is one of the plurality of sensors and that has detected the object;
associating, in a first path that is a part of the path, the identifier with an installation position of the detection-complete sensor in a reception order of a plurality of the identifiers, based on a plurality of the known installation positions of the plurality of sensors;
receiving, from a detection-incomplete sensor that is one of the plurality of sensors and that has not detected the object, reception strength information including an identifier of the detection-incomplete sensor and a reception strength of a signal of another one or more of the plurality of sensors in the detection-incomplete sensor; and
associating, for the detection-incomplete sensor installed on a second path that is a rest of the path, the identifier of the detection-incomplete sensor and an installation position of the detection-incomplete sensor, based on the reception strength information and an installation-position relation with the plurality of sensors.

5. A sensor system, comprising:
a plurality of sensors that is installed along a path and detects an object traveling through the path; and
an information processing apparatus that associates an identifier of each of the plurality of sensors and a known installation position of a corresponding one of the plurality of sensors, wherein
the information processing apparatus comprises:
reception circuitry, which, in operation, receives an identifier transmitted by a detection-complete sensor that is one of the plurality of sensors and that has detected the object; and
control circuitry, which, in operation, associates the identifier and an installation position of the detection-complete sensor, based on the received identifier and at least one of a plurality of the known installation positions of the plurality of sensors, wherein
the control circuitry, in a first path that is a part of the path, associates the identifier with the installation position of the detection-complete sensor in a reception order of a plurality of the identifiers, based on the plurality of known installation positions of the plurality of sensors,
the reception circuitry receives, from a detection-incomplete sensor that is one of the plurality of sensors and that has not detected the object, reception strength information including an identifier of the detection-incomplete sensor and a reception strength of a signal of another one or more of the plurality of sensors in the detection-incomplete sensor, and
the control circuitry associates, for the detection-incomplete sensor installed on a second path that is a rest of the path, the identifier of the detection-incomplete sensor and an installation position of the detection-incomplete sensor, based on the reception strength information and an installation-position relation with the plurality of sensors.
